(19) United States
(12) Patent Application Publication
(10) Pub. No.: US 2007/0284767 A1
(43) Pub. Date: Dec. 13, 2007

(54) Method and device for treating optical fibers

(76) Inventor: Raman Kashyap, Baie d'Urfe (CA)

Correspondence Address: Louis Tessier, P.O. Box 54029, Town of Mount Royal, QC, H3P 3H4, CA

(21) Appl. No.: 11/785,776

(22) Filed: Apr. 20, 2007

Related U.S. Application Data
(60) Provisional application No. 60/793,652, filed on Apr. 21, 2006.

(51) Int. Cl. B29D 11/00

(52) U.S. Cl. 264/1.24

(57) ABSTRACT

A method for treating an optical fiber according to a predetermined treatment, the optical fiber including a light guide and a coating, said coating covering, at least in part, said light guide, said method comprising: heating said coating along a portion thereof to a temperature such that said coating is treated according to said predetermined treatment; and transferring heat to said optical fiber at a rate small enough for substantially preventing said optical fiber from melting.

This application claims priority from U.S. Provisional Patent Application Ser. No. 60/793,652 filed Apr. 21, 2006.

### FIELD OF THE INVENTION

The present invention relates generally to the field of optics and is particularly concerned with methods and devices for treating optical fibers.

### BACKGROUND OF THE INVENTION

Glass based optical fibers are generally coated with a polymer layer to protect the surface of glass, which would otherwise deteriorate over a period of time. This deterioration process is primarily induced by the action of water vapour, chemicals or mechanical damage from contact with other surfaces. Normally for optical communications the protective coating is an acrylate polymer or soft silicone, depending on the type of cable that the fiber is ultimately housed in. For other applications such as fiber pigtails which need to remain flexible, the primary coating is tightly sheathed in a secondary polymer jacket which protects the primary coating from mechanical damage and adds strength to the lead. For optical fiber jumper cables, the secondary coated fiber may be surrounded by Kevlar fibers and cabled in a plastic tube to provide a rugged structure.

Optical fibers can also be coated with a thin, hard, hermetic coating of carbon to allow the fiber to be used in environmentally harsh conditions such as at elevated temperatures and/or in corrosive surroundings. Recently, polyimide has featured as a specialist coating. This material has excellent mechanical and chemical resistance properties, and has been used widely in industry as a masking material or for providing electrical insulation. Coating optical fibers, for example, allows them to be used in sensing applications. These coating may also reduce the diffusion into the glass of gases such as hydrogen that affect performance of the fiber. These specially coated fibers make a more rugged fiber structure and are therefore attractive for a number of applications in devices that are used in difficult environments.

It is necessary to remove any such coatings prior to splicing two fibers together, as the polymer may contaminate the fiber end and block the coupling of light from one optical fiber to the other. Generally, the coatings are not exactly concentric with respect to the fiber core, and therefore cannot be used for alignment between two fiber ends. Polymer coating on optical fibers can be removed by mechanical stripping with a wire stripper. This process removes the secondary and primary coating together, leaving the glass fiber bare for cleaving and splicing. Cleanliness and mechanical integrity of the optical fiber are of prime importance when preparing them for splicing. Additionally, any serious degradation of the mechanical or optical properties of the optical fiber may compromise performance of the splice over the long term. Mechanical stripping is difficult for stripping the coating of metal, carbon or polyimide from a coated optical fiber.

Another method of stripping-off most coatings the optical fiber is by immersion of the coated fiber into a bath of hot sulphuric acid. This is a very successful technique but is not generally preferred as it poses severe hazard for the operator in the field. A safer method is needed and this is the subject of our current invention.

Accordingly, there exists a need for improved methods and devices for treating optical fibers, such as, for example, to modify or strip-off the coating of an optical fiber.

It is a general object of the present invention to provide such methods and devices.

### SUMMARY OF THE INVENTION

In a first broad aspect, the invention provides a method for treating an optical fiber according to a predetermined treatment, the optical fiber including a light guide and a coating, said coating covering, at least in part, said light guide, said method comprising:

heating said coating along a portion thereof to a temperature such that said coating is treated according to said predetermined treatment; and

transferring heat to said optical fiber at a rate small enough for substantially preventing said optical fiber from melting.

In some embodiments, said predetermined treatment includes removing said coating along a portion of said optical fiber, and said temperature is high enough to remove said coating along said portion of said optical fiber.

For example, heating said coating includes producing an electrical arc substantially adjacent said coating. In another example, heating said coating includes irradiating said coating with a laser beam.

In a variant, heating said coating includes heating said coating in an atmosphere substantially deprived of oxygen.

Generally, the present invention provides a novel method usable for the removal of most primary coatings from the surface of an optical fiber. This is accomplished by applying localized heating to the tip of the fiber or any other region of the fiber. This may be applied, for example, by a series of weak or continuous electrical discharges or, alternatively, by pulses of light or continuous wave (CW) light from a laser beam. Such modification can be carried out in a controlled manner so as to allow removal of just the coating over for example approximately 0.5 mm and longer by moving the fiber relative to the heat source, without substantially affecting the optical properties of the optical fiber. This method has been demonstrated to not only remove standard polymer based primary coating, but also metal, polyimide and carbon etc. coatings. However, in alternative embodiments of the invention, the coating is removed over longer portions of optical fibers.

The object of the invention may be achieved by applying a controlled electrical discharge or laser light to a local region of the fiber. In a specific embodiment of the invention, the discharge or laser light treatment is applied digitally, in short pulses or continuously so that the coating bears the brunt of the heating affect, rather than the underlying optical fiber. The heat supplied to the fiber is only sufficient to remove the coating without melting the fiber.

In an alternative embodiment, the quality of the stripping may be monitored on a video camera for precise removal of difficult coatings, providing visual inspection during the removal of the coating as well feedback to the discharge to control the rate of stripping.

Most coatings are easily removed by adjusting several parameters such as strength of arc and/or the speed of stripping. However, other problems may occur when stripping coatings such as polyacrylates that are highly inflammable and which are prone to catching fire on the striking of the arc. The result of the polymer catching fire is that the optical fiber may be damaged or deformed and rendered fragile. It is difficult to prevent the polymer from catching fire. It is necessary to degrade only the coating rather than the fiber. In [U.S. Pat. No. 5,954,974], an infra-red laser is used to ablate a coating; infrared radiation (such as carbon dioxide laser radiation at 10.6 microns) can also be absorbed by the optical fiber. We therefore propose a visible or short wavelength laser (UV) that is preferentially absorbed by the coating. Once this coating is removed, the process is self terminating, as the optical fiber is predominantly transparent to the radiation and does not absorb it. In alternative embodiments of the invention, any radiation that is substantially absorbed by the coating but only slightly or not absorbed by the optical fiber is used. Further, in embodiments wherein the fiber is stripped using an electric arc, the electric arc may be adjusted in, position, duration, voltage and current as before to only degrade the polymer without affecting the optical fiber.

The electrical unit used to generate the electric arc is an inverter for example one of many that are used for striking Cold Cathode Fluorescent Lamps (CCFL). We modify the operation of the inverter in several ways that renders it suitable for the purpose of generating a controllable arc by altering the voltage supplied to the inverter rather than modulating the time width of the input voltage, as it is normally done in commercial inverters. However, the problem then remains that to strike the arc over a gap between the electrodes (for example of order 0.5-1 mm), requires a high voltage (for example 2-5 kV). This is usually difficult to achieve using miniature commercial inverters. We therefore modify our device so that the operating voltage may be increased several times the recommended supply voltage. If this is done, it generally destroys the inverting transformer by causing electrical breakdown. We have solved this problem by designing a special circuit.

In some embodiments of the invention, the combustion of the coating is self-limited by using a substantially hermetically sealed treatment chamber containing a section of fiber to treat, the treatment chamber having dimensions such that a concentration of oxygen in the treatment chamber falls below a concentration sufficient to maintain combustion substantially before completion of combustion of all the coating contained in the chamber, or at about the same time at which all the coating contained in the chamber completes combustion. In other embodiments of the invention, an inert gas is used to flush air out of the treatment chamber such that relatively low oxygen concentrations, or about zero oxygen concentrations, are maintained in the chamber. In yet other embodiments of the invention, the treatment chamber is dimensioned and configured such if the coating tries to catch fiber, the gasses produced expand and purge the cavity relatively rapidly, thereby depleting it of oxygen and self-terminating the ignition of the coating.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

An embodiment of the present invention will now be disclosed, by way of example, in reference to the following drawings in which:

FIG. 1 is a schematic representation of a cleaved optical fiber with a specialist primary coating such as polyimide.

FIG. 2a is a schematic representation of a typical arrangement used for stripping of coatings on the optical fiber using an electrical discharge by the method of this invention.

FIG. 2b is a schematic representation of a typical arrangement used for removal of coatings on the optical fiber using a focused laser beam by the method of this invention.

FIG. 3 is a schematic representation of the tip of the optical fiber, indicating for this embodiment, the area in which the coating removal occurs.

FIG. 4 is a photographic representation after the application of 2 discharge pulses by the method of this invention at the end of a fiber.

FIG. 5 is a photographic representation of the region of optical fiber in which the local removal of the coating takes place in the middle of a fiber.

FIG. 6 is a photographic representation of the fiber after an extended region of the coating has been removed.

FIG. 7 is a schematic representation of the device that transports the optical fiber through the region of the heat zone synchronously with the application of the electrical discharge.

FIG. 8 shows the Optical fiber 2 held in fiber clamps 12 joined by a mechanical arrangement 14 which is mounted on a translation stage 13 and moves in the direction indicated by 15. 11 shows the distance between the clamps.

FIG. 9 is a schematic of the time dependence of the voltage supplied to the HV unit, with an initial spike 14a starting at time T0 followed by a decay to level 15a at time T1 and finally down to a low voltage at time T2.

FIG. 10 shows a schematic of the electrodes 16 with a fiber 17 placed between the electrodes and housed in a heat resisting and insulating tube 18, in a typical manifestation of the current invention. An inlet tube 20 is another manifestation of the current invention. The arc is shown as 19 in FIG. 10.

FIG. 11 shows a cross-section of the split chamber with one electrode in position with a hole 22 in the bottom part of the chamber. The hole is loose around the electrode to allow the chamber to be opened by sliding action along the length of the electrode. Alternatively, a lid housing half the split chamber may be lifted on a hinge so that the heating region is accessible and the fiber may be introduced into the chamber. When the lid is closed, a small chamber is formed by the two halves, reducing the air volume surrounding the fiber.

FIG. 12 shows the fixed chamber 23 and the movable chamber 24, with the movement direction of the chamber shown as 25, but could also be in another direction, by modifying the design of the chamber, as will be evident to a person skilled in the art, for example as described in the last paragraph.

### DETAILED DESCRIPTION

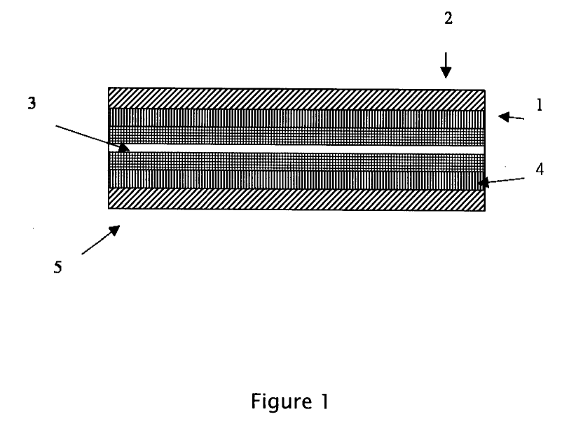

FIG. 1 shows the cleaved end (1) of an optical fiber (2) with a coatings (5, 5a).

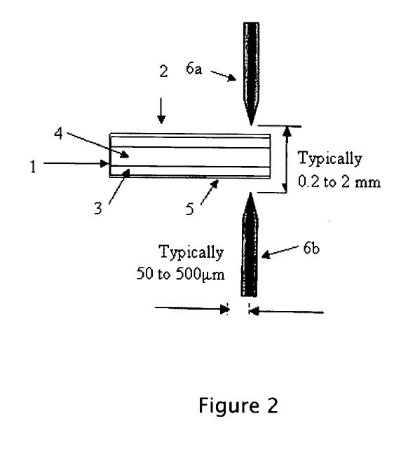

FIG. 2a is a schematic representation of one embodiment of the arrangement used to realize the removal of the coating (5), of this invention. In the prior art, electric-sparks have been used to remove debris loosely deposited on ends of optical fibers prior to fusion splicing of optical fibers by melting the two ends. These sparks are intended only to “kick” off any dirt the end. An optical fiber (2) may have a core (4) and may have a cleaved end (1). The core (4) could for example have a diameter of 1 to 100 microns or greater, while the uncoated fiber could have an overall diameter on the order of 125-500 microns. The cladding could be a single layer, or could be fabricated with two or more layers and both the core and the cladding could have refractive indices which are graded in the radial direction. The optical fiber cladding (3) may be encapsulated in a protective glass or polymer or other coating as shown in FIG. 2a (5a), and it may be metallized for soldering or other purposes. The fiber end (1) by which the fiber is terminated could be a cleaved end or a fiber lens fabricated by polishing, etching, drawing, or any other known method, and it could be wedge-shaped or of any other shape suited to the application for which it is intended.

In the embodiment of the invention of FIG. 2, an electrical discharge is established between two electrodes positioned near the tip of the fiber (1). The electrodes (6a and 6b) may be of tungsten, graphite or any other suitable material capable of sustaining a repeated electrical discharge. Representative dimensions are shown in FIG. 2, but these could be adjusted by a person skilled in the art, combined with selection of the electrical parameters of the process, as required to provide the required degree of processing. The electrical pulses causing the electrical discharge between the electrodes (6a and 6b) may be of any suitable intensity and duration, with the geometry selected, for giving a stepwise removal of the coating on the fiber and without melting the fiber. For example, pulses could be in the form of a square wave or any other shape having typically amplitude between one and 500 milliamperes and duration on the order of 1 to 100 microseconds or even continuous. Time between pulses is typically on the order of one tenth of a second but may be less or several seconds or longer, and this time may be controlled either automatically or by manually triggering the treatment pulses. Different types of materials used to make the optical fiber may require either shorter or longer duration discharges as well as greater or smaller discharge currents. It will be evident to a person skilled in the art that the precise geometrical and electrical parameters necessary to achieve the desired result will depend on humidity, atmospheric pressure, type of fiber end, fiber size, fiber type, ambient temperature and many other parameters. Any combination of suitable geometric and electrical parameters that achieves the objects of this invention falls within its scope.

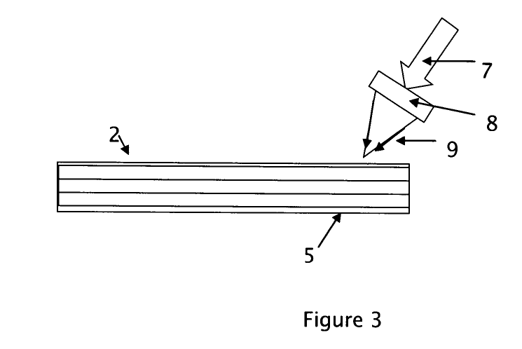

FIG. 3 is a schematic representation of a second embodiment of the arrangement used to realize the coating modification of this invention. A laser beam (7) is focused by a lens or system of lenses (8) such that the focused beam (9) is incident on the fiber that is to be stripped. As for the embodiment of FIG. 2, the laser light may be pulsed with pulses of any suitable intensity and suitable duration or continuous, with the geometry selected, for giving a stepwise or continuous removal of the coating on the fiber. Pulses could have duration on the order of 1 to 100 microseconds or more, and time between pulses may be on the order of one tenth of a second or longer and may be controlled either automatically or by manually triggering the treatment pulses. Different types of materials used to make the optical fiber may require either shorter or longer duration pulses as well as greater or smaller intensity of the treatment light. A carbon dioxide laser is well suited to this application. It will be evident to a person skilled in the art that the precise geometrical and laser parameters necessary to achieve the desired result will depend on humidity, atmospheric pressure, type of fiber-end, fiber size, fiber type, ambient temperature and many other parameters. Any combination of suitable geometric and laser parameters that achieves the objects of this invention falls within its scope.

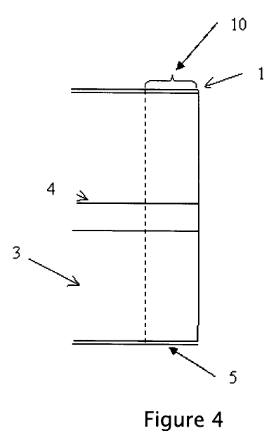

FIG. 4 shows schematically the region (10) of a fiber at which stripping is to be carried out by the method of this invention. The fiber may have a metallization coating or some other coating such as carbon or polyimide coating (5). This metallization may for example be an electrolytically-deposited coating of a few microns of nickel and a thin flash of gold (less than 1 micron). Alternatively, it may be a vacuum deposited coating such as, for example, 50 nm of titanium, 100 nm of platinum and 200 nm of gold. All such metallization coatings can be removed precisely and locally with application of a single or a few electrical discharges or light pulses or by continuous exposure to electrical discharge or laser light, by the method of this invention. The power level is such that a first single, several discharges, light pulses or continuous exposure to electrical discharges or light, do not measurably affect the glass of the fiber, but volatilize the thin metal/polyimide or other coating on the surface of the fiber. Continuing application of discharge or light pulses results in progressive removal of the coating, for example in the region (11).

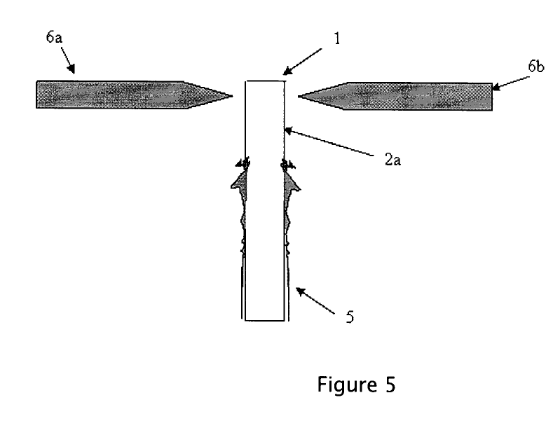

FIG. 5 shows the end of a fiber that has been stripped (2a) of its coating (5). In this case a polyimide coated fiber having a coating of a few microns thick was used. Successive discharges were applied until the best conditions were found to allow the coating to be stripped successfully.

During modification of fiber coating by the method of this invention, it is sometimes useful to monitor the surface visually as shown in FIG. 5, as certain coatings may be difficult to remove and for which a video camera may be used, a technique which also falls within the scope of this invention.

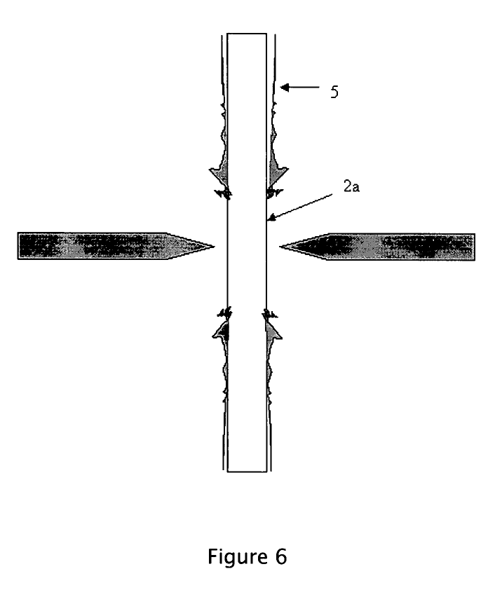

FIG. 6 shows a schematic of a fiber that has been stripped (2a) of its polyimide coating (5) in the middle of a coated region using the technique descried in this invention.

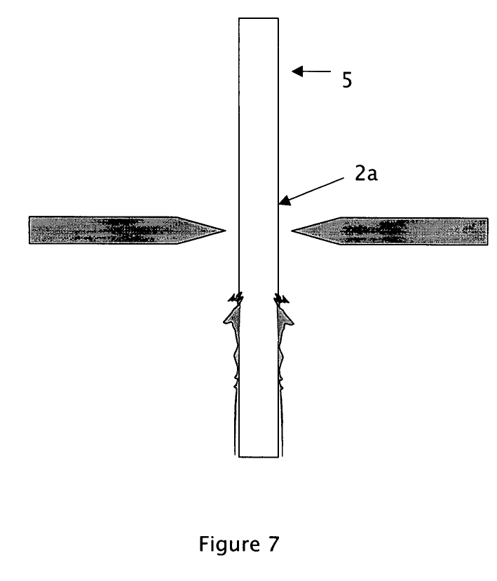

By translating the optical fiber relative to the electrical-discharge at the electrodes (6a, 6b) such that the coated section of the fiber enters or leaves the discharge area, subsequent sections of the optical fiber may be stripped synchronously, thereby extending the region of the stripped fiber to an arbitrary length. FIG. 7 shows a schematic of an extended stripped region of bare fiber (2a) using the technique of translating the fiber. It is clear to a person skilled in the art that the fiber needs to move relative to the discharge or light, so that the fiber could for example be stationary and the electrodes are moved relative to the fiber.

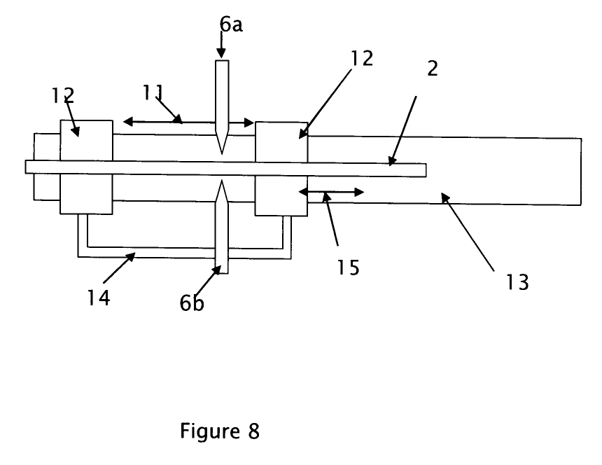

FIG. 8 shows the schematic of the system used to modify extended regions of the coating. The fiber (2) is held in a carriage formed by two optical fiber chucks (12a, 12b) mounted on translation stages below (12a) and (12b), separated by a distance (11) and linked with a rigid adjustable connector (14). The glide rail (13) allows the stages to move in a given direction perpendicular to the direction of the discharge, so that the fiber remains in the discharge region as shown by the direction arrow (15). It should be understood that this invention is not limited to the specific embodiments described above but that various modifications obvious to those skilled in the art, including the use of the method with optical fibers fabricated from polymer or from different glass compositions, may be made therein without departing from the scope of the following claims.

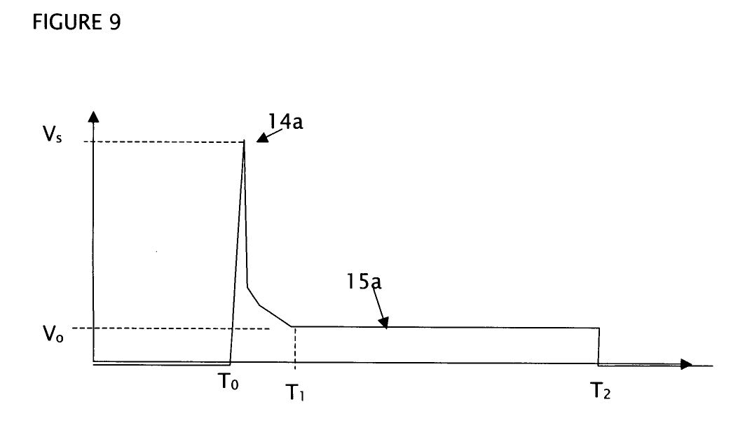

In order to strike the arc, we use a commercially available miniature inverter circuit used for lighting CCFLs. Unfortunately, in order to strike the arc in air, we need a high voltage which is difficult to achieve with the available inverters. In order to increase the output voltage, the transformer has to be modified. We have solved this problem by increasing the supply voltage several fold the recommended operating voltage. It is not recommended to use a high voltage on these inverters, as it destroys the transformers. We use a potting compound to entirely immerse only the transformer. This scheme allows the operating voltage to be increased well beyond (around 4-5 times) the specified operating voltage, and we are therefore able to use the device reliably. To control the power delivered to the fiber, we generate a high voltage spike Vs (of order 1 ms duration) 14 in FIG. 9 at time T1 to initiate the air breakdown and then reduce the operating power supply voltage to Vo, 15 after a short time T2, using an adjustable time constant electrical circuit. This ensures that the arc may be sustained at voltages lower than would be otherwise possible. If the high voltage is sustained for a length of time, it may melt the fiber. The voltage 15 is also adjustable to allow for processing different types of optical fibers. A typical strike and operating voltage is shown in FIG. 9.

In the current embodiment, the fiber is typically fed through a small hole in the tube 18 so that it is free to be translated past the electrodes. The air is confined within the tube such that when the arc is struck, there is insufficient air available to sustain a significant ignition of flammable products produced by the action of the arc on the polymer. The action of removal of the coating drives out the air out of the chamber, exhausting it of oxygen. The fiber is free to move, but the restricted air flow, severely limits continued burning of the polymer, as the coating breakdown products continue to be expelled from the chamber.

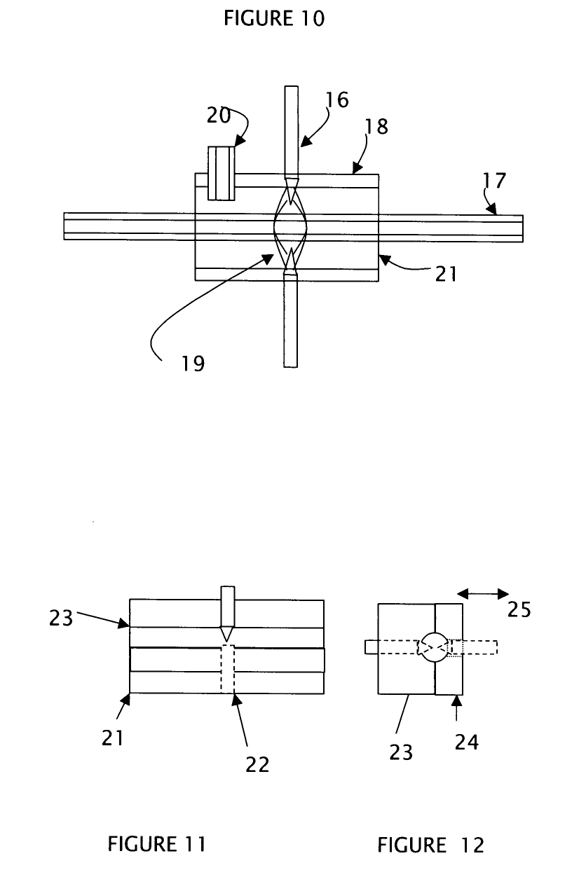

In another embodiment also shown in FIG. 10, a tube inlet 20 allows the injection of inert gases, such as argon, should the self-extinguishing process described in the previous paragraph not be sufficient, so that the decomposition products produced under the electrical discharge are swept away through a large hole 21 at the end of the tube 18.

In some embodiments of the invention, an outlet in fluid communication with the chamber in which the coating is removed allows the removal of inert gases from this chamber and its safe evacuation to a location away from a user of the invention.

In another embodiment of the invention, a split chamber is used as shown in FIG. 2. One half of the chamber 23 is substantially snugly fit around one electrode while the other half 24 can slide over the electrode so that the “chamber” is created around the fiber when the two halves come together as shown in FIG. 12. The diameter of this chamber is larger than the diameter of the fiber. For example, and non-limitingly, the diameter of the fiber could be 1 mm and the diameter of the tube formed by the two halves may be 2 mm, sufficient to allow the arc of the laser light to degrade the coating and expel the gasses quickly from the chamber, thus quickly eliminating the oxygen from the electrode region. Typically, the material that forms the chamber and is in contact with the electrodes is insulating, from example made of glass, ceramic or high temperature resisting plastic, although the rest of the material may be made with a metal such as aluminium. The split chamber also aids the removal of debris from the breakdown products of the coating as it is removed.

In order to remove the charred ends of the fiber coating at the edges of the stripped region, a mechanical wire stripper or any convenient method may be used for safe removal without substantially affecting the mechanical properties of the fiber, is used to carefully remove a small section (for example <1 mm) of the coating.

It is evident, to a person skilled in the art, without loss of generality, that several variations of the scheme may be employed to achieve the desired result, and that the method proposed is a practical implementation of one of these. For example it is clear to a person skilled in the art that the position of the electrodes relative to the fiber may be altered such that the heat delivered to the fiber may be regulated, as may be the speed of translation of the fiber past the arc. It may also be clear to a person skilled in the art that the translation of an optical fiber may be effected by a pair of rotating pinch wheels and a fiber tensioning system which could allow the continuous feeding of the fiber past the arc for stripping of an optical fiber of any arbitrary length.

The above suggests the following methods and devices:

1. A method for modifying or removing the coating on an optical fiber or waveguide by application of heat to a localized region,

2. A method for modifying or removing the coating on an optical fiber or waveguide as in point 1, in which localized heating is applied using an electrical discharge between two or more electrodes located substantially adjacent to the end of a fiber or to a localized region,

3. A method for modifying or removing the coating on an optical fiber or waveguide as in point 1, in which localized heating is applied using focused laser radiation,

4. A method for modifying or removing the coating on an optical fiber or waveguide as in point 1 and 3, in which the laser providing localized heating has a wavelength of 980 nm wavelength laser or less,

5. A method for modifying or removing the coating on an optical fiber or waveguide as in point 1 to 3, in which the electrical discharge or laser radiation is pulsed or continuous such that the treatment of the optical fiber proceeds in controlled steps, with pulse durations of 1 microseconds or longer and intervals of 1 microsecond to several seconds in the case of pulsed treatment.

6. A method for modifying or removing the coating of an optical fiber or waveguide as in point 1, 2 and 5, in which the electrical discharge has amplitude of between 1 and to 500 milliamperes.

7. A method for modifying or removal of the coating on an optical fiber or waveguide as in point 1 to 6, in which the optical fiber is monitored while the modification is in process and the monitored image is used to control the degree of modification.

8. A method for modifying or removal of the coating of an optical fiber or waveguide as in point 1 to 6, in which fiber and the heated region are translated synchronously relative to each other so that continuous or extended sections of the fiber are processed,

9. An apparatus for modifying or removal of a coating on an optical fiber or waveguide as per points 1 to 3 and 8.

10. A method as described in point 1 in which the ignition or partial burning of flammable polymer coatings is suppressed by the introduction of a confining chamber around the electrodes surrounding the optical fiber,

11. A method as per point 10 in which suppression of ignition and continued burning of polymers is restricted by the flow of an inert gas,

12. A method as per point 1, 2 and 3, in which the optical fiber is a polymer coated wire or insulating rod,

13. A method as per point 1, 2, 3 and 4 in which the energy source for the removal of the coating is laser radiation is at a wavelength around ˜800 nm,

14. A method as per point 1, 2, 3, 4 and 5 in which the laser radiation is in the wavelength range (400-1100 nm),

15. A method as per point 1, 2, 3, 4 and 5 in which the laser radiation is in the UV to visible wavelength range (200-400 nm),

16. A method as per point 10, in which the chamber is split in two for easy insertion and removal of the fiber.

17. A method as per point 1, 2, 3, 4 in which the electrical arc unit is a dc-ac inverter,

18. A method as per point 1, 2, 3, 4 in which the electrical discharge unit is modulated in time to initiate the arc and sustain a stripping cycle,

19. A method as per point 1, 2, 3, 4, 17, 18, in which the inverter transformer is immersed in a potting compound,

20. A method as per point 9 in which the short charred region of the remaining coating at the edges of the stripped region of fiber are mechanically or otherwise stripped.

21. An apparatus for performing any of the methods described in points 1 to 20.

A person skilled in the art could easily recognize different modifications and variations to the described scheme to achieve substantially similar or different results on optical fibres of different types, or even polymer coated metal wires.

Although the present invention has been described hereinabove by way of preferred embodiments thereof, it can be modified, without departing from the spirit and nature of the subject invention as defined in the appended claims.

What is claimed is:

1. A method for treating an optical fiber according to a predetermined treatment, the optical fiber including a light guide and a coating, said coating covering, at least in part, said light guide, said method comprising:
heating said coating along a portion thereof to a temperature such that said coating is treated according to said predetermined treatment; and
transferring heat to said optical fiber at a rate small enough for substantially preventing said optical fiber from melting.

2. A method as defined in claim 1, wherein said predetermined treatment includes removing said coating along a portion of said optical fiber, and said temperature is high enough to remove said coating along said portion of said optical fiber.

3. A method as defined in claim 1, wherein heating said coating includes producing an electrical arc substantially adjacent said coating.

4. A method as defined in claim 1, wherein heating said coating includes irradiating said coating with a laser beam.

5. A method as defined in claim 1, wherein heating said coating includes heating said coating in an atmosphere substantially deprived of oxygen.
